(19) United States
(12) Patent Application Publication
(10) Pub. No.: US 2006/0216450 A1
(43) Pub. Date: Sep. 28, 2006

(54) Degradation resistant expandable tubing and method and system for manufacture thereof

(76) Inventor: Jay Arthur Ballard, Mapleton, UT (US)

Correspondence Address: KUNZLER & ASSOCIATES, 8 EAST BROADWAY, SUITE 600, SALT LAKE CITY, UT, 84111, US

(21) Appl. No.: 11/087,478

(22) Filed: Mar. 22, 2005

(51) Int. Cl. F16L 11/04

(52) U.S. Cl. 428/36.91

(57) ABSTRACT

An article of manufacture, apparatus, system, and method are disclosed for providing degradation-resistant expandable tubing. Degradation resistance is supplied by integrally bonding a degradation resistant liner of similar expansion capacities to the expandable tubing.

### BACKGROUND OF THE INVENTION

1. Field of the Invention

The illustrated embodiments of the invention relate to the field of expandable tubing and particularly lined expandable tubing of enhanced degradation resistance.

2. Description of the Related Art

Some tubing such as latex tubing is produced in production quantities by repeatedly dipping a mandrel through a bath of liquid which solidifies on the mandrel. The mandrel may be produced from a material to which the solidified liquid will not adhere or is coated with a material that prevents the solidified liquid from adhering to the mandrel when the mandrel is removed from the finished latex tube.

Production of tubing such as latex tubing is most often an automated process in which a continuous length of mandrel is led by a series of rollers through a liquid bath of material and subsequently through a drying or curing area after which the process is repeated. Each repeated “dipping” results in an increase in the wall thickness of the tube being produced. This process may be repeated until the wall thickness reaches the desired dimension. The finished tube may then be subjected to additional curing processes after which the mandrel is removed from the interior of the tubing. The finishes product is a tube of homogeneous material such as latex rubber.

In practice, it has been possible to alter the composition of the first few layers of deposited such as latex by mixing other compatible materials such as liquid nitrile rubber with the primary material in an attempt to improve compatibility with materials that would come in contact with the interior of the finished tubing. This approach is limited, however, by the increased difficulty in extracting the mandrel from the finished tube, which can commonly have a length in excess of 100 feet. Typically, only a small percentage of materials other than the primary material can be added before it becomes impossible to remove the mandrel from the finished tubing. The addition of blended materials to the primary material also affects the properties of the finished product, often decreasing the desirable properties of the finished tube. Therefore, a need exists in the industry for an integrally lined expandable tube and a method and apparatus for the manufacture thereof.

### SUMMARY OF THE INVENTION

The illustrated embodiments describe an expandable tube having superior degradation resistant qualities and systems and methods for manufacturing such tubing.

Tubing such as latex tubing may be employed in many applications in which it comes in contact with oils and chemicals. For example, a latex tubing may be used to dispense frosting in the cake decorating art. The inherent expandability and “memory” of latex results in an even feed pressure and smooth flow of frosting within the tube out of the decorating tip. In a further example, a latex tube may be used in the pump mechanism of a soap dispenser. In these and other examples, however, oils and other chemicals in the dispensed material may cause degradation and disintegration of the latex, shortening the life of the tube and contaminating the material in the tube with latex particles.

A properly composed liner can protect the latex from exposure to materials within the tube. To be effective, the liner must be able to adhere to the latex tubing either by natural adhesion or through an intermediary coating applied to the liner. Additionally, the liner material must have sufficient expansion capacity to meet the expansion requirements of the application for which the tubing will be used. For example, a similar expansion rate of the latex tubing and the liner prevents separation of the liner material from the body of the latex tube. In such a scenario the tube may supply the memory that the non-latex liner may lack in returning to the original dimensions.

The prior art, however, has failed to supply such tubing, or a method and apparatus for the manufacture thereof. Attempts to produce such tubing have been defeated by the lack of a means for of applying the liner either to the mandrel upon which the expandable tubing will be deposited or directly to the interior of the expandable tubing.

The present invention addresses the aforementioned challenges in the prior art. In certain embodiments a mandrel is inserted into a liner tube. In one embodiment, the liner is placed within an open ended rigid chamber having gas permeable walls. The ends of the liner may be stretched over and sealed against a surface on each end of the chamber. A vacuum is drawn surrounding the chamber, causing the atmospheric pressure within the liner tube to force the liner tube to expand against the inner walls of the chamber. A mandrel is subsequently inserted into the lumen of the expanded liner. After insertion of the mandrel, the vacuum is removed allowing the liner tube to contract around the mandrel. The liner may be thermal plastic or other appropriate material.

In another embodiment, the liner material may be extruded over the outside diameter of the mandrel. The prepared mandrel may be fed through a specially prepared die that centers the mandrel within the extrusion path of the liner material. The described process enables production of a very thin liner.

In a further embodiment, the liner and mandrel may be co-extruded in a single processing system. Other methods may also be employed to arrive at the liner mandrel combination, producing a liner that is physically supported by the mandrel during a variety of subsequent operations and from which the mandrel may be removed when desired.

In one embodiment, an expandable tubing material is applied to the liner clad mandrel by a repeated dipping process standard in the industry. Once the wall thickness of the combined liner and applied tubing material reaches the required dimension, the finished tube may be removed from the production equipment. The post curing process may be performed in a manner similar to that employed for homogeneous expandable tubing. In a further embodiment the post curing process may be modified to be compatible with the liner material used. The mandrel is then removed from the inside of the tubing using processes common for the removal of a mandrel from homogeneous expandable tubing. In one embodiment the expandable tubing comprises latex. In further embodiments the expandable tubing may comprise other material appropriate for the proposed use.

### BRIEF DESCRIPTION OF THE DRAWINGS

In order that the advantages of the invention will be readily understood, a description of the invention will be rendered by reference to specific embodiments that are illustrated in the appended drawings. Understanding that these drawings depict only typical embodiments of the invention and are not therefore to be considered to be limiting of its scope, the embodiments of invention will be described and explained with additional specificity and detail through the use of the accompanying drawings, in which:

FIG. 1 is a perspective end drawing illustrating one embodiment of degradation-resistant expandable tubing of the present invention.

FIG. 2 is a cut away perspective drawing illustrating one embodiment of an expandable tube complex.

FIG. 3 is a side cross sectional view illustrating one embodiment of a mandrel insertion apparatus of the present invention.

FIGS. 4-8 are side cross sectional views illustrating a Mandrel Insertion Apparatus of the present invention in various phases of operation.

FIG. 9 a side cross sectional illustrating one embodiment of a dual extrusion apparatus in accordance with the present invention.

FIG. 10 is a process flow diagram illustrating one embodiment of a manufacturing process of the present invention.

FIG. 11 is a process flow diagram illustrating an alternative embodiment of a manufacturing process of the present invention.

FIG. 12 is a flow chart diagram illustrating one embodiment of a manufacturing method for an expandable tube, in accordance with the present invention.

FIG. 13 is a flow chart diagram illustrating a further embodiment of a manufacturing method for an expandable tube, in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Samples:

Sample product has been produced using a liner made from a Thermal Plastic Elastomer material that was purchased from Kent Elastomer as their product K3826. This material has elongation properties that closely approximate those of latex rubber. In one test run approximately 25 feet of this material was installed over a ½″ diameter, thick walled, silicone tube that was used as a mandrel. The liner was installed using the open ended vacuum chamber method described above. The mandrel with the applied liner was sent to a major manufacturer of latex tubing where the finished tube was produced using standard production equipment.

Latex was applied over the supplied mandrel with liner to a finished diameter of approximately one inch. The finished assembly was returned to the inventor's facility where the mandrel was removed using a standard forced air procedure. The adhesion of the latex to the liner was found to be excellent, with the liner and latex appearing to be inseparable by mechanical means. The finished product was tested and found to have properties closely approximating a homogeneous latex tube of the same dimensions. The liner provided complete resistance to vegetable oil with which the finished lined tube was tested. A homogeneous latex tube was tested in conjunction with the testing of the lined tube. The homogeneous latex tube was not resistant to the vegetable oil and the inside surface of the tube quickly degraded with repeated expansion and contraction.

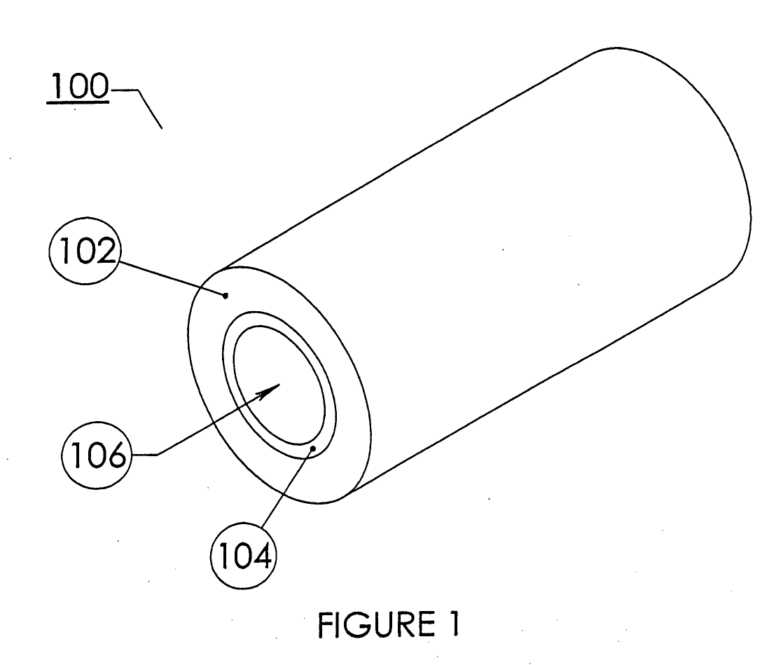

FIG. 1 is a perspective end drawing illustrating one embodiment of degradation-resistant expandable tubing 100 of the present invention. As depicted, the tubing 100 includes an expandable tube 102, an integral liner 104, and a hollow, expandable lumen 106. The tubing 100 has superior expansion and contraction qualities and resists degradation from contact with oils and other chemicals.

The expandable tube 102 provides the strength, expandability, and configurational memory required by various uses. The expandable tube 102 may comprise a flexible, durable material with good configurational memory, such as a pure latex rubber. In certain embodiments, the expandable tube 102 comprises a latex rubber with various additives, nitrile, or an other suitable material known in the art.

The liner 104 protects the interior of the expandable tube 102 from contact with oils and other chemicals that may cause degradation of the tube 102. The liner 104 is composed of an elastic, degradation-resistant material selected to bond with the expandable tube 102. The liner may be composed of various thermal plastic elastomers, thermo set elastomers such as silicone a, urethane, or other suitable materials known in the art.

In one embodiment, the liner 104 and expandable tube 102 have similar expansion capabilities and are bonded to resist mechanical separation. Thus, the expandable tube 102 and the liner 104 may function as an integral unit, preventing separation of the two elements during use.

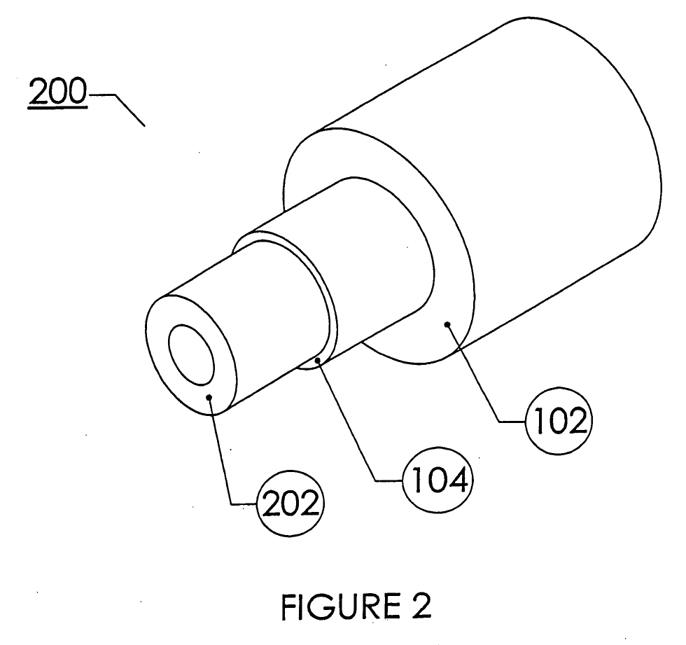

FIG. 2 is a cut away perspective drawing illustrating one embodiment of an expandable tube complex 200. As depicted, the expandable tube complex 200 includes an expandable tube 102, a liner 104, and a mandrel 202. The expandable tube complex 200 enables the protective liner 104 to be applied to the inside surface of the expandable tube 102.

The mandrel 202 supplies a support matrix upon which the expandable tube 102 may be deposited or extruded. The mandrel may be a pipe or a solid rod and may be composed of or coated with a variety of non-bonding materials selected for easy release of the tube, including silicone rubber and polypropylene. The liner 104 is applied to the mandrel 202 before deposition or extrusion of the expandable tube 102. The expandable tube 102 is applied over and may bond with the liner 104.

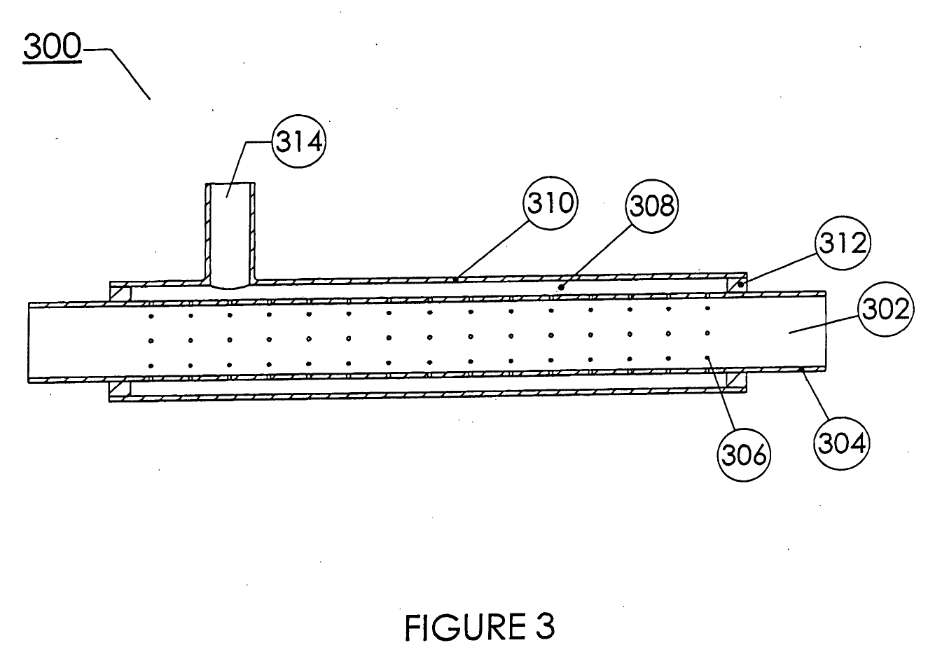

FIG. 3 is a side cross sectional view illustrating one embodiment of a mandrel insertion apparatus 300 in accordance with the present invention. As depicted, the mandrel insertion apparatus 300 includes a central chamber 302, a central chamber wall 304, perforations 306, an outer chamber 308, an outer chamber wall 310, an air-tight seal 312, and an evacuation port 314. The mandrel insertion apparatus 300 provides a means for inserting a mandrel 202 into a tube liner 104.

In the illustrated embodiment, the central chamber 302 is defined by the central chamber wall 304, with the perforations 306 in the central chamber wall 304 rendering the chamber wall gas-permeable. Other embodiments include a central chamber wall 304 of rigid mesh. In a further embodiment the central chamber wall 304 may include slits, louvers, or other openings.

The outer chamber 308 surrounds the central chamber wall 304. The outer chamber wall 310 defines the outer chamber 308. The ends of the outer chamber wall 310 may be sealed to the central chamber wall 304 with an air-tight seal 312. In the depicted embodiment the outer chamber wall 312 includes the evacuation port 314.

Air may be evacuated from the outer chamber 308 through the evacuation port 314. Air may pass into the outer chamber through the perforations 306 in the central chamber wall 304 and be evacuated, creating a vacuum in the central chamber.

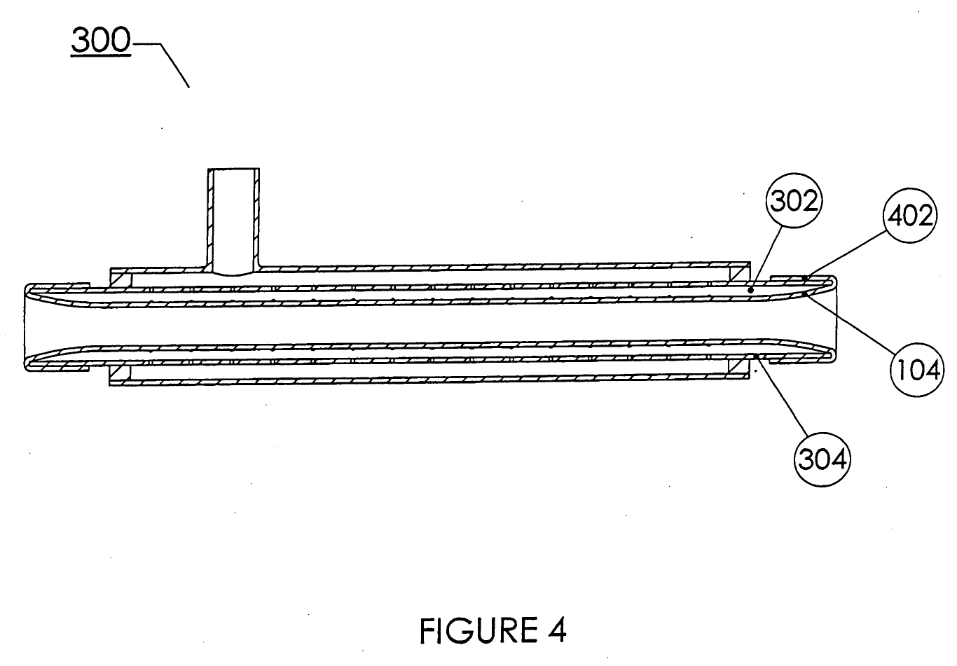

FIG. 4 is a side cross sectional view illustrating one embodiment of the mandrel insertion apparatus 300 in a first phase of operation. As depicted, in the first phase of operation the liner tube 104 is inserted into the central chamber 302, with the ends of the tube 104 turned back over the ends of the central chamber wall 304 forming an air-tight seal 402. In further embodiments the ends of the liner tube 402 may be clamped, taped, glued, or otherwise fastened to the central chamber wall 304.

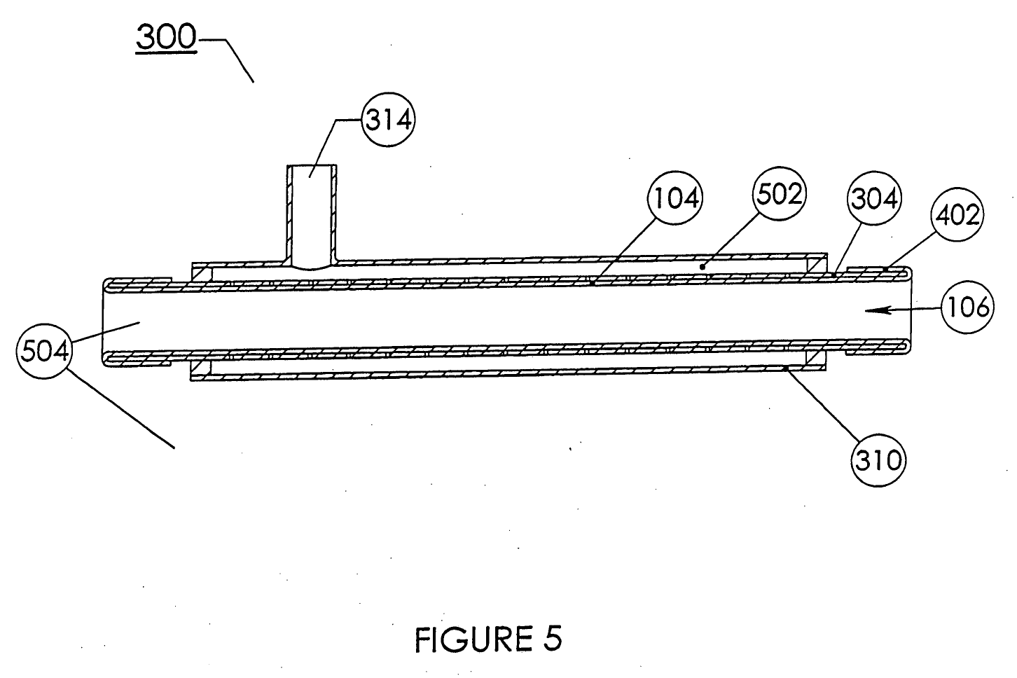

FIG. 5 is a side cross sectional view illustrating one embodiment of a mandrel insertion apparatus 300 in a second phase of operation. As depicted, in the second phase of operation air is evacuated from the outer chamber 308 through the evacuation port 314 creating a vacuum 502. The permeable nature of the central chamber wall 304 enables a vacuum 502 to also be created between the central chamber wall 304 and the walls of the liner tube 104. The lumen 106 of the liner tube is open at the ends to atmospheric pressure 504, which forces the walls of the liner tube against the inner surface of the central chamber wall 304, expanding the lumen 106.

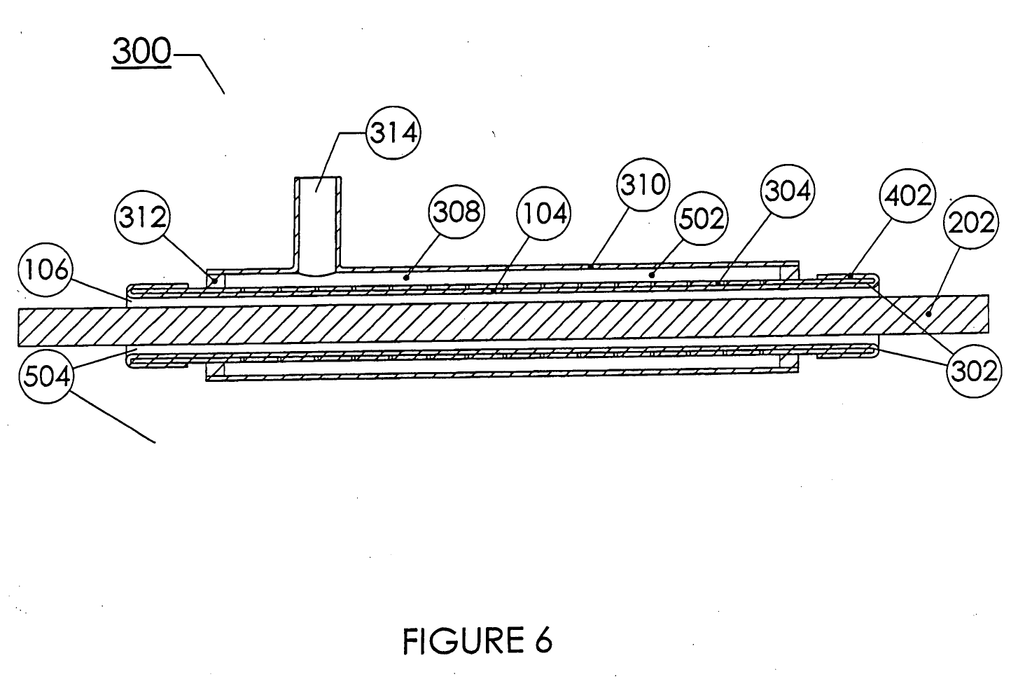

FIG. 6 is a side cross sectional view illustrating one embodiment of a mandrel insertion apparatus 300 in a third phase of operation. As depicted, in the third phase of operation, mandrel 202 is inserted in the expanded lumen 106 of the liner tube 104. The mandrel may be easily inserted because the liner tube 104 is expanded and held rigid against the central chamber wall 304 by atmospheric pressure 504 opposing the vacuum 502 within the outer chamber 308.

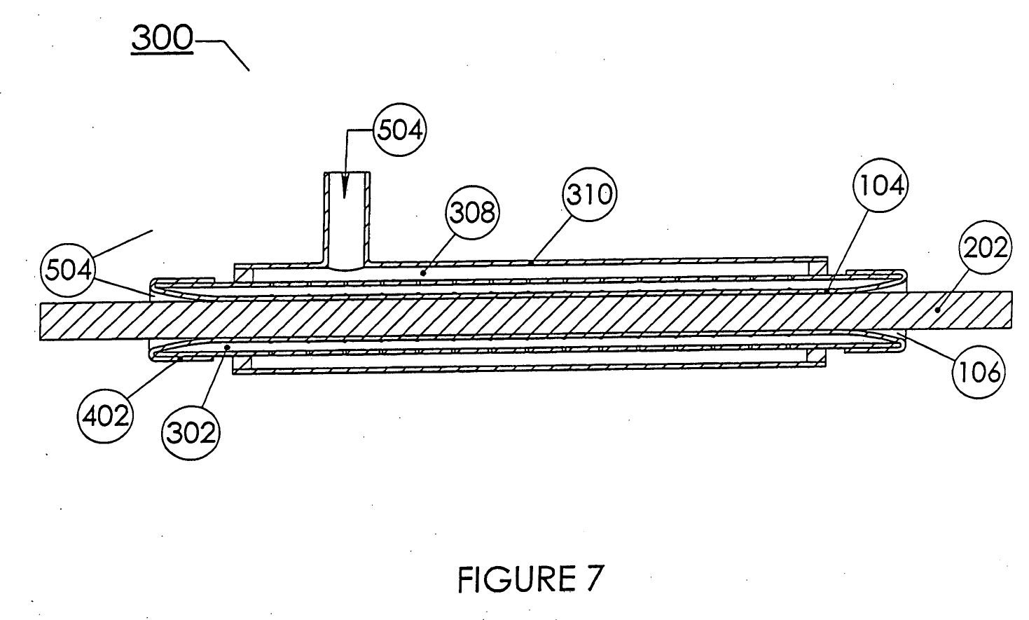

FIG. 7 is a side cross sectional view illustrating one embodiment of a mandrel insertion apparatus 300 in a fourth phase of operation. As depicted, in the fourth phase of operation an atmospheric pressure 504 is allowed into the outer chamber 308, thus neutralizing the atmospheric pressure inside the liner tube 104 and enabling the liner tube 104 to contract around the mandrel 202.

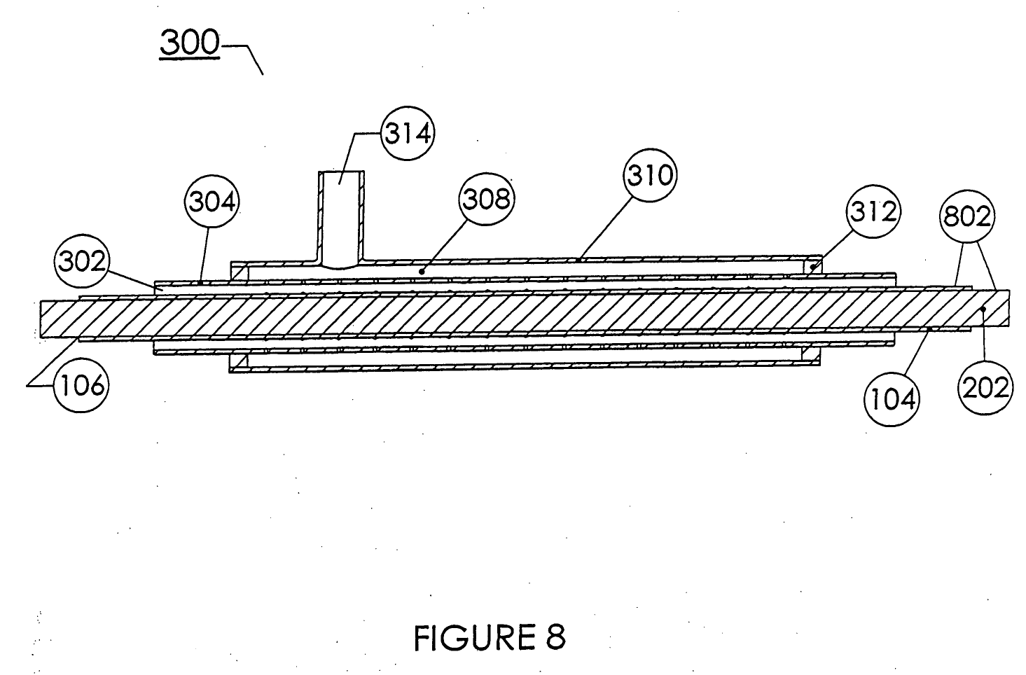

FIG. 8 is a side cross sectional view illustrating one embodiment of a vacuum mandrel insertion apparatus 300 in a last stage of operation. As depicted, the in the last stage of operation the ends of the liner tube 104 are detached from the inner chamber wall 304 and the liner-clad mandrel 802 is then removed from the apparatus 300. The liner-clad mandrel 802 may then be subjected to expandable tubing application. The expandable tubing may be latex rubber or other tubing material requiring a liner.

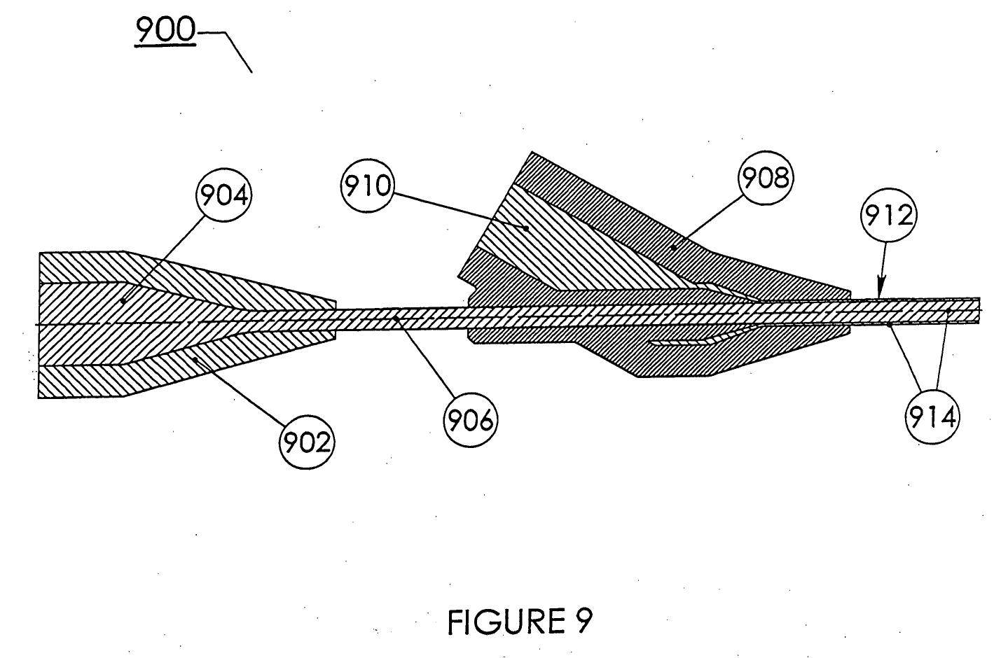

FIG. 9 is a side cross sectional view illustrating one embodiment of a dual extrusion apparatus 900 in accordance with the present invention. As depicted, the dual extrusion apparatus 900 includes a mandrel extrusion die 902, mandrel extrusion material 904, an extruded mandrel 906, a liner extrusion die 908, liner extrusion material 910 and an extruded liner-clad mandrel 914. As illustrated, the dual extrusion apparatus 900 enables a mandrel to emerge from the extrusion process clad with an extruded liner tube. In other embodiments the mandrel 906 may be completed before being fed through a liner extrusion die or inserted into a pre-formed liner tube.

In the illustrated embodiment a mandrel extrusion die 902 receives the mandrel extrusion material 904 and extrudes a mandrel 906. The extruded mandrel 906 is fed through a liner extrusion die 908, which is loaded with the liner extrusion material 910. The extruded liner 912 is then applied to the moving mandrel 906, creating an extruded liner-clad mandrel 914.

The mandrel 202 and the extruded mandrel 906 may be functionally equivalent, or may be manufactured of different material. Likewise, the liner clad mandrel 802 and the extruded liner-clad mandrel 914 may be functionally equivalent, or may be manufactured of different materials as appropriate to the method of manufacture and end use.

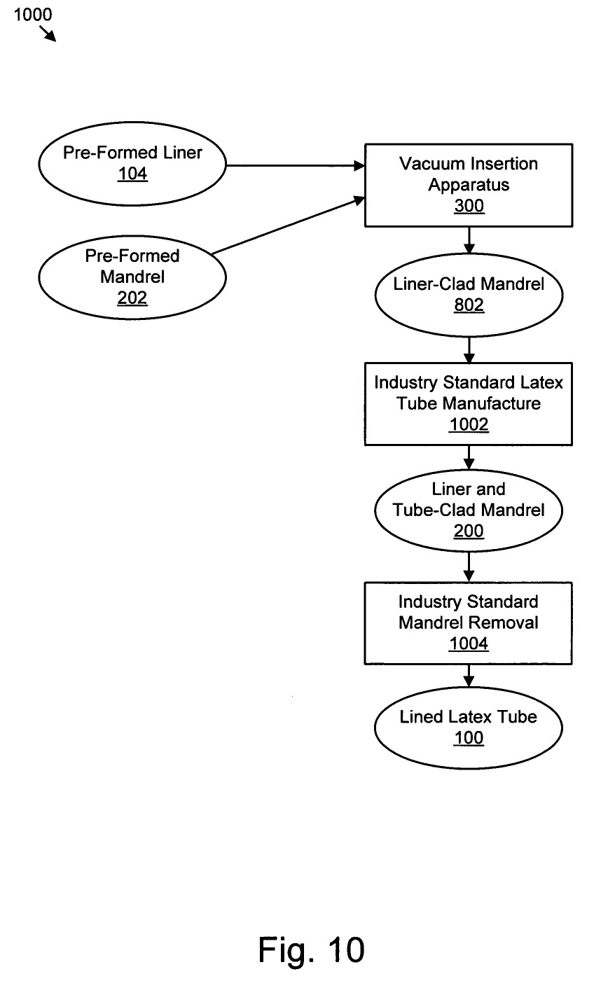

FIG. 10 is a process flow diagram illustrating one embodiment of a manufacturing system 1000 in accordance with the present invention. As depicted, the manufacturing system 1000 includes a mandrel insertion apparatus 300, a pre-formed liner tube 104, a pre-formed mandrel 202, a resulting liner-clad mandrel 802, industry standard expandable tubing manufacture 1002, an expandable tubing complex 200, and industry standard mandrel removal 1004, producing a lined expandable tube 100.

The illustrated system of manufacture enables a pre-formed mandrel to be inserted into a pre-formed liner tube. The pre-formed mandrel 202 may be composed of various materials known in the art designed to resist adherence to a liner tube 104, or may be treated with a release material. The liner tube 104 may be composed of thermal plastic elastomer or other material known in the art. An expandable tubing material such as latex may be applied to the liner-clad mandrel 802 through industry standard latex tube manufacture 1002 such as successive dipping in a latex bath, or other methods known in the art. In a further embodiment the material such as latex may include performance enhancing or other additives. The industry standard removal 1004 of the mandrel 202 may comprise forcing air between the mandrel 202 and the liner 104, or other procedure known in the art.

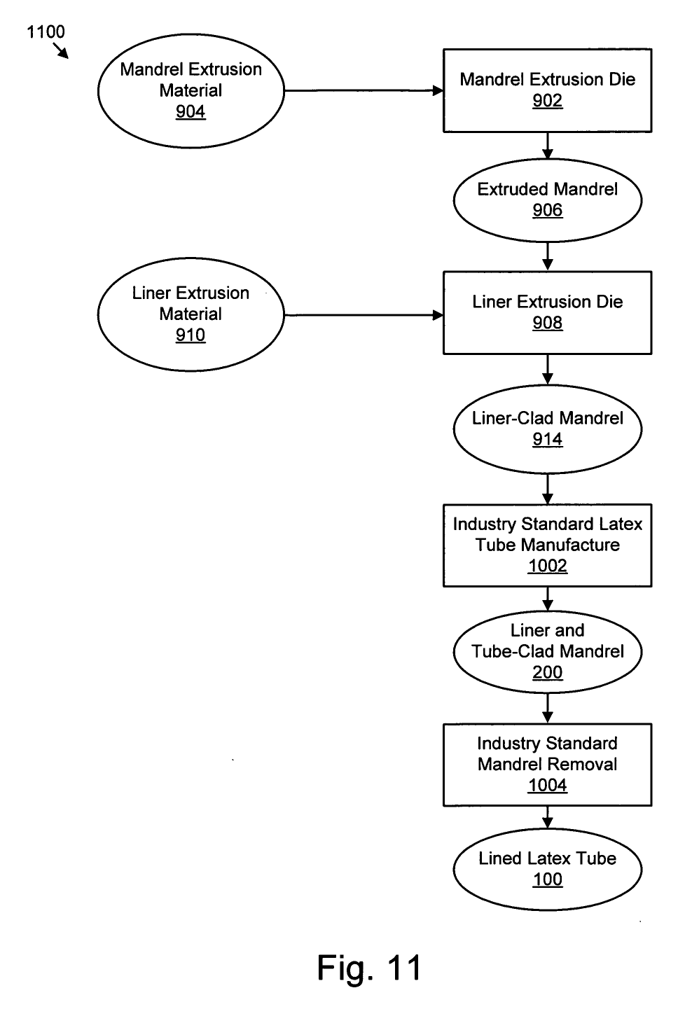

FIG. 11 is a process flow diagram illustrating an alternative embodiment of a system of manufacture 1100. As depicted, the system of manufacture 1100 includes a mandrel extrusion die 902, mandrel extrusion material 904, an extruded mandrel 906, a liner extrusion die 908, liner extrusion material 910, an extruded liner 112, an extruded liner-clad mandrel 914, industry standard latex or other expandable tube manufacture 1002, an expandable tube complex 200, and industry standard mandrel removal 1004, producing lined expandable tubing 100.

The illustrated system of manufacture enables the creation of a liner-clad mandrel 914 through a two step successive extrusion operation. Latex or other expandable tubing material may be applied to the liner-clad mandrel 914 through industry standard latex tube manufacture 1002 such as successive dipping in a latex bath, or other methods known in the art. In a further embodiment the latex or other expandable tubing material may include performance enhancing or other additives.

The industry standard removal 1004 of the mandrel 906 may comprise forcing air between the mandrel 906 and the liner 112, or other procedure known in the art. In a further embodiment the system may include a mandrel degradation device such as a chipper and the mandrel material 904 may be recycled through the mandrel extrusion die 902.

The schematic flow chart diagrams that follow depict order and labeled steps indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Arrow types and line types are understood not to limit the scope of the corresponding method. Indeed, some arrows or other connectors may be used to indicate only the logical flow of the method. For instance, an arrow may indicate a waiting, curing, or monitoring period of unspecified duration between enumerated steps of the depicted method. Additionally, the order in which a particular method occurs may or may not strictly adhere to the order of the corresponding steps shown.

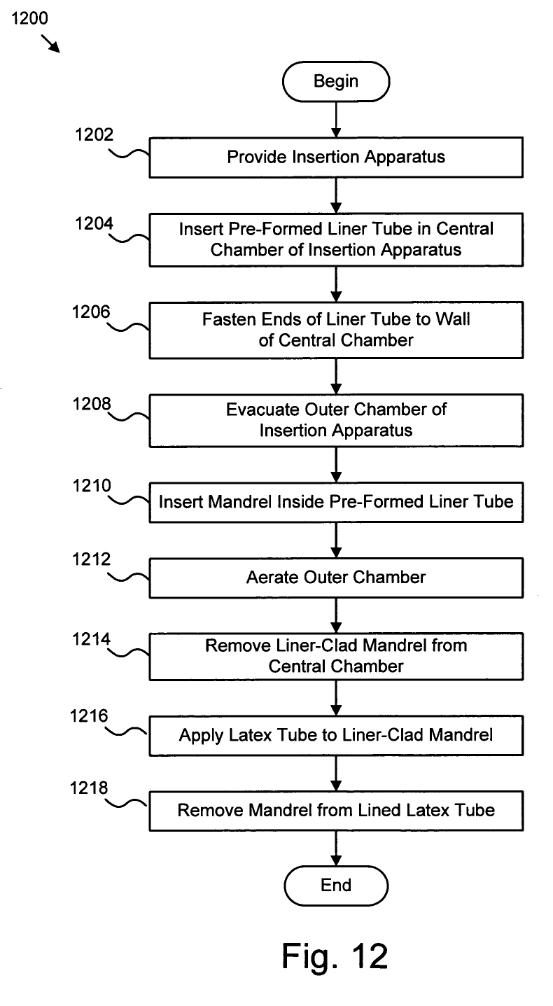

FIG. 12 is a schematic flow chart diagram illustrating one embodiment of a tubing manufacturing method 1200 in accordance with the present invention. As depicted, the manufacturing method 1200 includes providing 1202 a mandrel insertion apparatus; inserting 1204 a pre-formed liner tube 104 in the insertion device; fastening 1206 the ends of the liner tube 104 to the device with an air-tight seal; evacuating 1208 the insertion device; inserting 1210 a mandrel 202 in the expanded lumen 106 of the pre-formed liner tube 104; aerating 1212 the outer chamber; removing 1214 the liner-clad mandrel 802 from insertion device; applying 1216 expandable tubing to the liner-clad mandrel 802; and removing 1218 the mandrel 202 from the lined expandable tubing 100.

The mandrel insertion apparatus may be similar or different in form to the mandrel insertion device 300. In one embodiment, the mandrel insertion apparatus may be constructed of metal. Alternatively, the mandrel insertion apparatus may be constructed of rigid plastic or other appropriate material. The mandrel insertion apparatus may also be constructed of a combination of materials.

In one embodiment, the mandrel 202 may be a polypropylene tube. The mandrel 202 may also be a silicon tube, a solid cylinder, a rope or cord or other appropriate support structure. The liner tube 104 may be thermoplastic or may be composed of other material formulated to bond to expandable tubing, release easily from a mandrel and match the expansion properties required for the end use of the expandable tubing.

In one embodiment, pure latex may be applied to the liner clad mandrel 802. Alternatively, latex with additives or other types of natural or synthetic rubber or other expandable tubing material.

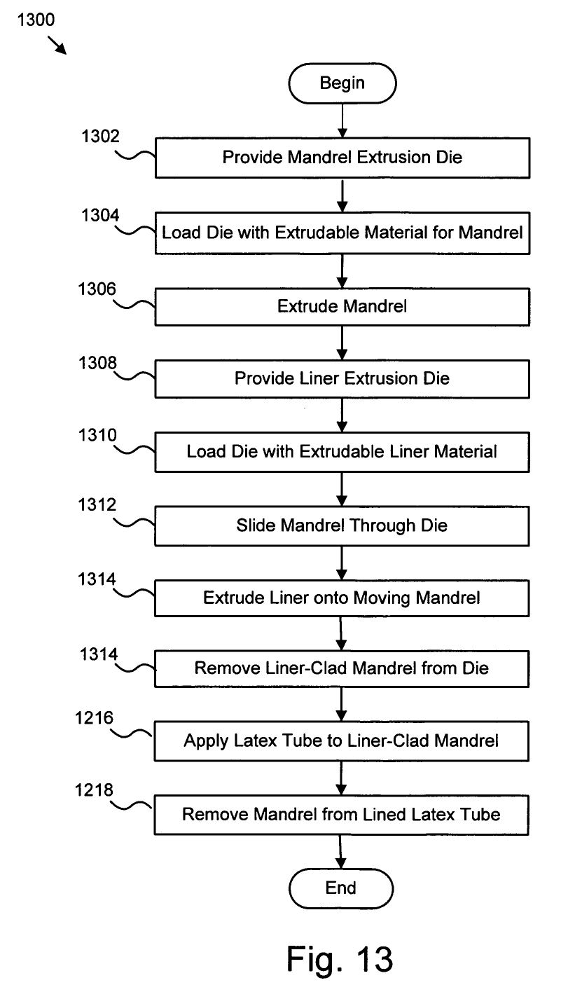

FIG. 13 is a schematic flow chart diagram illustrating an alternative embodiment 1300 of a tubing manufacturing method in accordance with the present invention. As depicted, the method 1300 includes: providing 1302 a mandrel extrusion die; loading 1304 the extrusion die with extrudable mandrel material; extruding 1306 a mandrel; providing 1308 a liner extrusion die; loading 1310 the extrusion die with extrudable liner material; feeding 1312 the mandrel through the liner extruding die; extruding 1314 a liner onto the moving mandrel; removing 1316 a liner-clad mandrel from the die; applying 1216 expandable tubing to the liner-clad mandrel; removing 1218 the mandrel from the lined expandable tube 100.

In one embodiment, the extrusion system employs a dual extrusion apparatus such as depicted in FIG. 900. In another embodiment, a pre-formed mandrel is fed through a liner-extrusion die. An alternative embodiment may employ a combination of a mandrel extrusion and a vacuum installation apparatus. The mandrel may be extruded directly into the expanded lumen of a pre-formed liner tube or the completed mandrel may be inserted after extrusion. A further embodiment may include the steps of breaking down the mandrel material and recycling it through the mandrel extrusion die.

In one embodiment, the extrudable liner material may be thermoplastic. In other embodiments, the extrudable liner material may be composed of other compound formulated to bond to latex, release easily from a mandrel and match the expansion properties required for the end use of the latex tube.

In one embodiment, pure latex may be applied to the liner clad mandrel 802. In other embodiments, latex with additives other types of natural or synthetic rubber or other expandable tubing material may be applied.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. an article of manufacture comprising:
an expandable tube; and
an expandable, degradation-resistant liner integrally bonded to the interior surface of the expandable tube.

2. The article of manufacture of claim 1, wherein the expandable tube comprises latex.

3. The article of manufacture of claim 2, wherein the latex tube includes additives.

4. The article of manufacture of claim 1, wherein the liner comprises thermal plastic.

5. The article of manufacture of claim 1, wherein the liner comprises at least one of silicone and polyurethane.

6. An article of manufacture comprising:
an expandable tube;
an expandable, degradation-resistant liner integrally bonded to the interior surface of the expandable tube; and
a mandrel inserted in the longitudinal lumen of the liner.

7. The article of manufacture of claim 1, wherein the mandrel comprises material of sufficient flexibility to withstand the tubing manufacture process and sufficient rigidity to support the liner and tubing during manufacture.

8. The article of manufacture of claim 6, wherein the mandrel is pre-formed

9. The article of manufacture of claim 6, wherein the mandrel is hollow.

10. The article of manufacture of claim 8, wherein the mandrel comprises silicon rubber.

11. The article of manufacture of claim 8, wherein the mandrel comprises PVC.

12. The article of manufacture of claim 6, wherein the mandrel is extruded.

13. The article of manufacture of claim 6, wherein the liner is pre-formed.

14. The article of manufacture of claim 6, wherein the liner is extruded on the mandrel.

15. The article of manufacture of claim 1, wherein the liner comprises a material capable of bonding to the expandable tubing material and releasing from the mandrel

16. An apparatus for manufacturing tubing, the apparatus comprising:
a longitudinal center chamber having gas-permeable, rigid walls;
a longitudinal outer chamber of a diameter greater than the center chamber, having impermeable rigid walls;
the center chamber positioned inside the outer chamber; and
the space between the center chamber and the outer chamber being closed on each end with an air-tight seal.

17. The apparatus of claim 16, wherein the outer chamber includes an evacuation port.

18. The apparatus of claim 16, wherein the walls of the center chamber include perforations at least one of perforations, slits, or louvers.

19. The apparatus of claim 16, wherein the walls of the center chamber comprise a rigid mesh.

20. A system for manufacturing tubing, the system comprising:
a mandrel insertion apparatus;
a pre-formed liner tube;
a pre-formed mandrel; and
a resulting liner-clad mandrel.

21. The system of claim 20, further comprising a latex application mechanism.

22. The system of claim 21, further comprising a mandrel removing mechanism.

23. A system for manufacturing tubing, the system comprising:
a mandrel extrusion die;
a source of extrudable mandrel material;
a liner tube extrusion die;
a source of extrudable liner tube material; and
a resulting liner-clad mandrel.

24. The system of claim 23, further comprising a latex application apparatus.

25. The system of claim 24, further comprising a mandrel removing procedure.

26. The system of claim 25, further comprising a mandrel chipping and recycling apparatus.

27. A method for manufacturing tubing, the method comprising:
providing an insertion apparatus;
inserting a pre-formed liner tube into the apparatus;
circumferentially fastening each end of the liner tube to the apparatus to form an air-tight seal leaving the lumen of the liner open;
evacuating the insertion apparatus:
inserting a mandrel into the lumen of the liner tube;
aerating the apparatus; and
removing the liner-clad mandrel from the apparatus.

28. The method of claim 27, further comprising applying expandable tubing material to the liner-clad mandrel.

29. The method of claim 28, further comprising removing the mandrel from the lined expandable tube.

30. A method for manufacturing tubing, the method comprising:
providing a mandrel extrusion die;
loading the die with extrudable mandrel material;
extruding a mandrel;
passing the extruded mandrel through a liner tube extruding die;
extruding a liner tube on the mandrel; and
removing the liner-clad mandrel from the die.

31. The method of claim 30, further comprising applying expandable tubing material to the liner-clad mandrel.

32. The method of claim 31, further comprising removing the mandrel from the lined expandable tube.

33. The method of claim 32, further comprising decomposing and recycling the used mandrel back into the mandrel extrusion die.
